(19) United States
(12) Patent Application Publication
(10) Pub. No.: US 2014/0169240 A1
(43) Pub. Date: Jun. 19, 2014

(54) Access Control Method, User Equipment, Access Network, and Communications System

(71) Applicant: Huawei Technologies Co., LTD, Shenzhen (CN)

(72) Inventor: Xiaozheng Han, Shanghai (CN)

(73) Assignee: Huawei Technologies Co., LTD, Shenzhen (CN)

(21) Appl. No.: 14/103,549

(22) Filed: Dec. 11, 2013

(30) Foreign Application Priority Data
Dec. 17, 2012 (CN) 201210548068.4

(51) Int. Cl. H04W 48/18

(52) U.S. Cl. CPC H04W 48/18
USPC 370/280; 370/328

(57) ABSTRACT

Embodiments of the present invention disclose an access control method, a user equipment, an access network, and a communications system. System information includes an uplink interference parameter and an access threshold. It is determined whether the uplink interference parameter is smaller than the access threshold. If the uplink interference parameter is smaller than the access threshold, uplink access is initiated to the access network. If the uplink interference parameter is not smaller than the access threshold, after a delay time, current system information is re-obtained and it is again determined whether the uplink interference parameter is smaller than the access threshold.

### CROSS-REFERENCE TO RELATED APPLICATION

This application claims priority to Chinese Patent Application No. 201210548068.4, filed on Dec. 17, 2012, which is hereby incorporated by reference in its entirety.

### TECHNICAL FIELD

The present invention relates to the field of communications, and in particular, to an access control method, a user equipment, an access network, and a communications system.

### BACKGROUND

A universal mobile telecommunications system (UMTS, Universal Mobile Telecommunications System) is a third-generation mobile communications system. As a major air interface solution for third-generation mobile communications in the world, wideband code division multiple access (WCDMA, Wideband Code Division Multiple Access) can provide a wider variety of services. Since release of a first full range of WCDMA standards by the third-generation partnership project (3GPP, 3rd Generation Partnership Project) at the end of 1999, WCDMA mobile communications systems have seen wider global commercial deployment.

A UMTS system includes a core network (CN, Core Network) and multiple radio network subsystems (Radio Network Subsystem, RNS). As shown in FIG. 1, RNSs form a UMTS terrestrial radio access network (UMTS Terrestrial Radio Access Network, UTRAN), where each RNS has a radio network controller (Radio Network Controller, RNC) and multiple base stations (NodeB). Each RNC is responsible for allocating radio resources for NodeBs under its control, and the NodeBs then provide the radio resources for user equipments (User Equipment, UE). Radio resources are configured according to cells. A cell is an area covered by radio resources provided by a NodeB. UEs on a cell use radio resources of the cell to establish radio channels for data sending and receiving with an RNC, for example, to establish an RRC link.

UEs receive system information (SI, System Information) on a primary common control physical channel (PCCPCH, Primary Common Control Physical Channel) of a serving cell. An RNC uses ASCs (Access Service Class) of system information blocks SIB5 and SIB6 to control access from UEs of different access service classes on each cell and access from different types of UEs, so as to prevent access congestion.

On the one hand, with the rapid increase in popularity of smart phones, “always online” of smart phones causes the phones to periodically generate heartbeat data and continuously initiate system access; on the other hand, M2M (Machine to Machine, machine to machine) products are booming and will see explosive development in the future. These low-priority users may access in batches in off-peak hours of common users such as at night and access extensively in special scenarios such as a power failure. As a result, system access from a multitude of users may be centralized in a short time, which significantly increases the probability of uplink access congestion. A WCDMA system is a self-interference system and the uplink is an interference limited system. That is, if a large number of UEs simultaneously access the system, an access network may fail to demodulate UEs normally because the minimum demodulation threshold is not met. Consequently, uplink congestion and even UL breakdown may occur.

To solve the problem on access of low-priority M2M users, 3GPP R11 introduces EAB (Extended Access Barring, extended access barring) and AC (Access Class, access class) for separate control over low-priority users as follows: AC0 to 9 may be controlled separately according to CS/PS domains and separate control may be further performed according to whether the control is on a PLMN (Public Land Mobile Network, public land mobile network) customized by operators or on an EPLMN (Equivalent PLMN, equivalent PLMN).

However, EAB introduced in R11 cannot solve access congestion of future common users or access congestion of low-priority M2M users in special scenarios (for example, extensive access in the case of a power failure). Particularly, in view of the rapid popularization of smart phones and upcoming large-scale commercial use of M2M, it is imperative to solve the problem of severe uplink access congestion caused when UEs are contending for UL access resources.

### SUMMARY

In view of this, embodiments of the present invention provide an access control method, a user equipment, an access network, and a communications system for solving the uplink congestion problem caused by extensive access.

In a first aspect, an access control method is provided, which includes: obtaining system information, where the system information includes an uplink interference parameter and an access threshold; determining whether the uplink interference parameter is smaller than the access threshold; and if the uplink interference parameter is smaller than the access threshold, initiating uplink access to an access network.

In a first possible implementation manner of the first aspect, the method further includes: if the uplink interference parameter is not smaller than the access threshold, after a delay time, re-performing the step of obtaining current system information and the step of determining whether the uplink interference parameter is smaller than the access threshold.

With reference to the first possible implementation manner of the first aspect, in a second possible implementation manner, the method further includes: obtaining a persistence scaling factor and a dynamic persistence level; and according to a persistence value calculated according to the persistence scaling factor and the dynamic persistence level, selecting an upper limit of a random probability value of the persistence value as the delay time.

With reference to the first possible implementation manner of the first aspect, in a third possible implementation manner, the system information further includes the delay time.

With reference to the first aspect, or the first possible implementation manner of the first aspect, or the second possible implementation manner of the first aspect, or the third possible implementation manner of the first aspect, in a fourth possible implementation manner, the access threshold is a default value preset by the access network according to a product type, an access service class, or a service type of a user equipment, or a dynamic change value set by the access network according to the uplink interference parameter.

With reference to the first aspect, or the first possible implementation manner of the first aspect, or the second possible implementation manner of the first aspect, or the third possible implementation manner of the first aspect, or the fourth possible implementation manner of the first aspect, in a fifth possible implementation manner, a value range of the access threshold is (−110, −70) in a frequency division duplex system or (−110, −52), in a time division duplex system, in units of dBm.

In a second aspect, an access control method is provided, which includes: obtaining an uplink interference parameter; setting an access threshold; and sending the uplink interference parameter and the access threshold to a user equipment (UE) so that the UE performs access control according to the uplink interference parameter and the access threshold.

In a first possible implementation manner of the second aspect, the method further includes: presetting a delay time; and sending the delay time to the UE so that when the uplink interference parameter is not smaller than the access threshold, the UE, after a wait for the delay time, re-obtains an uplink interference parameter and an access threshold of a next time point and performs access control.

In a second possible implementation manner of the second aspect, the method further includes: sending a persistence scaling factor and a dynamic persistence level to the UE, so that when the uplink interference parameter is not smaller than the access threshold, the UE calculates a delay time according to the persistence scaling factor and the dynamic persistence level, and after a wait for the delay time, re-obtains an uplink interference parameter and an access threshold of a next time point and performs access control.

With reference to the second aspect, or the first possible implementation manner of the second aspect, or the second possible implementation manner of the second aspect, in a third possible implementation manner, the step of setting an access threshold includes: setting a corresponding access threshold according to a product type of the UE, where the product type includes mobile phone of common user or M2M product.

With reference to the second aspect, or the first possible implementation manner of the second aspect, or the second possible implementation manner of the second aspect, in a fourth possible implementation manner, the step of setting an access threshold includes: setting a corresponding access threshold according to an access class type of the UE.

With reference to the second aspect, or the first possible implementation manner of the second aspect, or the second possible implementation manner of the second aspect, in a fifth possible implementation manner, the step of setting an access threshold includes: setting a corresponding access threshold according to a service type of the UE, where the service type includes a circuit switch (CS) service and a packet switch (PS) service.

With reference to the fifth possible implementation manner of the second aspect, in a sixth possible implementation manner, the PS service further includes a conversational class service, a streaming class service, an interactive class service, and a background class service.

In a third aspect, a user equipment is provided, which includes: a receiver, configured to obtain system information, where the system information includes an uplink interference parameter and an access threshold; an access controller, configured to determine whether the uplink interference parameter is smaller than the access threshold; and an access module, configured to initiate uplink access to an access network when the uplink interference parameter is smaller than the access threshold.

In a first possible implementation manner of the third aspect, the system information obtained by the receiver further includes a delay time; and when the uplink interference parameter is not smaller than the access threshold, the receiver is further configured to: after a wait for the delay time, re-obtain an uplink interference parameter and an access threshold of a next time point.

In a second possible implementation manner of the third aspect, the receiver is further configured to obtain a persistence scaling factor and a dynamic persistence level broadcast by the access network, and according to a persistence value calculated according to the persistence scaling factor and the dynamic persistence level, select an upper limit of a random probability value of the persistence value as a delay time; and when the uplink interference parameter is not smaller than the access threshold, after a wait for the delay time, re-obtain an uplink interference parameter and an access threshold of a next time point.

In a fourth aspect, an access network is provided, which includes: a radio network controller, configured to obtain an uplink interference parameter and set an access threshold; and a base station, configured to send the uplink interference parameter and the access threshold to a user equipment (UE) so that the UE performs access control according to the uplink interference parameter and the access threshold.

In a first possible implementation manner of the fourth aspect, the radio network controller is further configured to preset a delay time; and the base station is further configured to send the delay time to the UE, so that when the uplink interference parameter is not smaller than the access threshold, the UE, after a wait for the delay time, re-obtains an uplink interference parameter and an access threshold of a next time point and performs access control.

In a second possible implementation manner of the fourth aspect, the base station is further configured to send a persistence scaling factor and a dynamic persistence level to the UE, so that when the uplink interference parameter is not smaller than the access threshold, the UE calculates a delay time according to the persistence scaling factor and the dynamic persistence level, and after a wait for the delay time, re-obtains an uplink interference parameter and an access threshold of a next time point and performs access control.

In a fifth aspect, a communications system is provided, which includes an access network and a user equipment (UE), where the access network obtains an uplink interference parameter and sets an access threshold, and sends the uplink interference parameter and the access threshold to the UE; the UE obtains the uplink interference parameter and the access threshold and determines whether the uplink interference parameter is smaller than the access threshold; and when the uplink interference parameter is smaller than the access threshold, the UE initiates uplink access to the access network.

In a first possible implementation manner of the fifth aspect, the access network further presets a delay time and sends the delay time to the UE; and when the uplink interference parameter is not smaller than the access threshold, the UE, after a wait for the delay time, re-obtains an uplink interference parameter and an access threshold of a next time point and performs uplink access control.

In a second possible implementation manner of the fifth aspect, the access network further sends a persistence scaling factor and a dynamic persistence level to the UE; the UE obtains the persistence scaling factor and the dynamic persistence level broadcast by the access network, and according to a persistence value calculated according to the persistence scaling factor and the dynamic persistence level, selects an upper limit of a random probability value of the persistence value as a delay time; and when the uplink interference parameter is not smaller than the access threshold, the UE, after a wait for the delay time, re-obtains an uplink interference parameter and an access threshold of a next time point.

Through the foregoing solutions, in the access control method, the user equipment, the access network, and the communications system provided by the embodiments of the present invention, access control is performed according to an uplink interference parameter. When the uplink interference level is high, access is delayed, and therefore, the probability of the uplink congestion problem caused by extensive simultaneous access is reduced.

### BRIEF DESCRIPTION OF DRAWINGS

To illustrate the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a structural diagram of a system of an existing UMTS;

FIG. 2 is a schematic diagram of an existing uplink access procedure;

FIG. 3 is a flowchart of an access control method according to Embodiment 1 of the present invention;

FIG. 4 is a flowchart of an access control method according to Embodiment 2 of the present invention;

FIG. 5 shows a user equipment according to Embodiment 3 of the present invention;

FIG. 6 is a structural diagram of an access network according to Embodiment 4 of the present invention; and

FIG. 7 is a structural diagram of a communications system according to Embodiment 5 of the present invention.

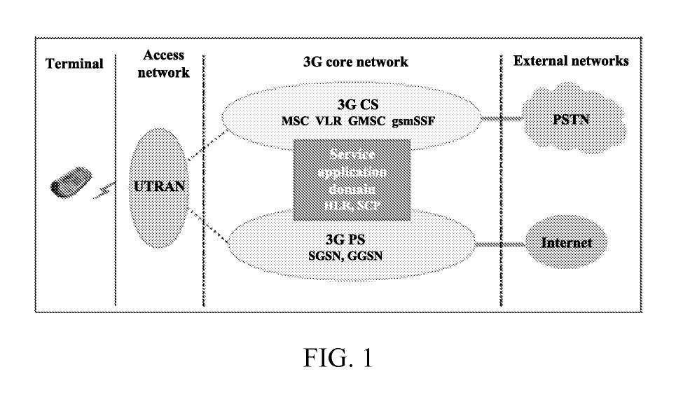

### DESCRIPTION OF EMBODIMENTS

For a better understanding of the technical solutions provided the present invention, the following briefs a typical procedure in which an existing user equipment UE accesses a base station in a serving cell. It should be known that the procedure is developed to better explain the technical solutions provided by the present invention but is not intended to limit the protection scope of the present invention. Any uplink access methods that are based on an existing access procedure and incorporate an access control ideology provided by the present invention shall fall within the protection scope of the present invention.

A user equipment (UE) has two running modes: an idle mode and a connected mode. After powered on, a UE stays in an idle mode and is distinguished by a non-access layer identifier such as an international mobile subscriber identification number (International Mobile Subscriber Identification Number, IMSI), a temporary mobile subscriber identity (Temporary Mobile Subscriber Identity, TMSI), or a packet temperate mobile subscription identity (Packet Temperate Mobile Subscription Identity, P-TMSIP-TMSI). A UE changes from an idle mode to a CELL_FACH or CELL_DCH state of a connected mode only when an RRC link is set up for the UE and changes from the connected mode back to the idle mode when the RRC link is released.

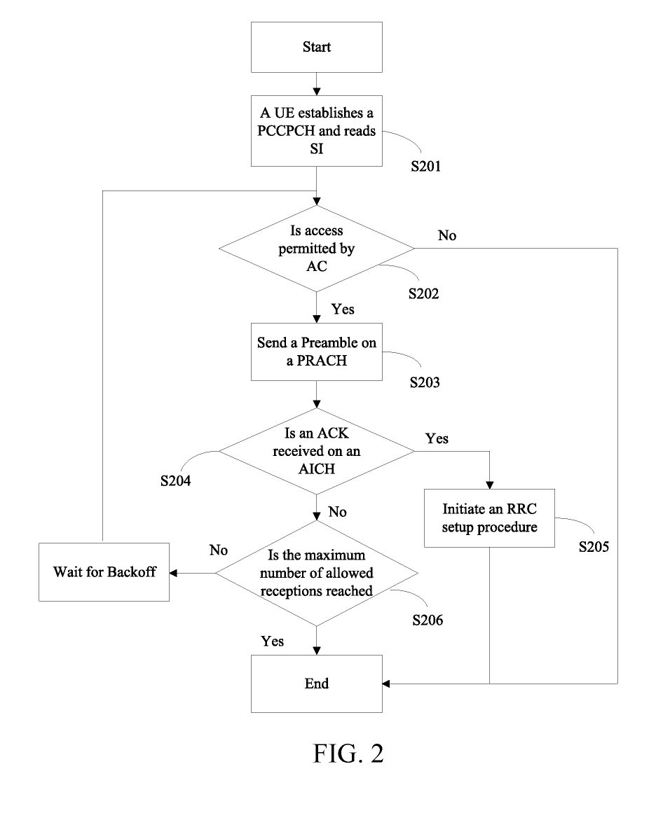

After changing from the idle mode to the connected mode, the UE accesses a UTRAN, as shown in FIG. 2. The main procedure includes:

S201. The UE first establishes a primary common control physical channel (Primary Common Control Physical Channel, P-CCPCH) with a base station on a UTRAN side and reads system information broadcast by the base station. The UTRAN includes system information of physical random access channels (Physical Random Access Channel, PRACH) in system information blocks SIB5, SIB6, and SIB7. A person skilled in the art should know that in 3GPP R5 and later versions, the system information is generally formed by a main information block (MIB), a scheduling block (Scheduling Block, SB), and a system information block (SYSTEM_INFORMATION_BLOCK, SIB). SIBs are classified and grouped according to whether they include static parameters or dynamic parameters and are sent cyclically in a certain format. SIB types include SIB1, SIB2, SIB3, SIB5, SIB5bis, and SIB7. Each system information block uses information elements (Information Element, IE) to carry system parameters. For example, 1. SIB1: includes NAS system information and information about timers and constants used by a UE in an idle state and a connected state; 2. SIB2: includes identifier ID information of a UTRAN registration area (UTRAN Registration Area, URA); and 3. SIB3: includes cell selection and reselection parameters, specifically including three IEs: Cell identity, Cell selection and re-selection info, and Cell Access Restriction, which are not described again herein.

S202. If an access controller (Access Controller, AC) on a UTRAN side allows the UE to access, turn to step S203; otherwise, end the access procedure.

S203. The UE sends a preamble to uplink (Uplink, UL) of the base station through a PRACH. A person skilled in the art should know that a preamble, in network communication, is a signal for synchronizing transmission sequences between two or more systems. It defines a transmission pulse in a specific sequence and is understood by a communications system as that “a UE is about to transmit data”.

S204. The UE determine whether acknowledgement (Acknowledgement, ACK) information from the base station is received on an acquisition indicator channel (Acquisition Indicator Channel, AICH). If the ACK information is received on the AICH, perform step S205; if no ACK information is received, perform step S206. According to 3GPP 25.321.11.2.2, if a preamble is sent but an access network does not respond, information on the AICH is not decoded correctly and the UE waits fixedly. If an NACK is received, the UE waits randomly.

S205. The UE initiates an RRC link setup procedure to the UTRAN for uplink access, so that the UE can establish a radio channel for transmitting and receiving data with the UTRAN by using radio resources of a cell where the UE is located.

S206. The UE determines whether the number of receptions of ACK information reaches a maximum number of allowed receptions. If the maximum number of allowed receptions is not exceeded, repeat step S204 after a wait for a delay time Backoff. As defined by 3GPP, Backoff is a delay time for compulsory retransmission in the case of a conflict.

In the future, with the rapid increase in popularity of smart phones and large-scale commercial use of M2M, UEs may encounter a more serious uplink access congestion problem. If unsolved, the congestion problem will lead to a vicious circle. When UEs are contending for UL access resources, a large number of UEs cannot access or initiate services and even UL breakdown may occur.

It should be noted that UEs in the present invention include but are not limited to smart phones, mobile communication terminals that support the UMTS such as Pads and PDAs, and M2M devices. M2M is developed by organically combining different types of communication technologies to implement machine-to-machine communication, machine-controlled communication, human-machine interactive communication, and mobile internet communication. The M2M enables information to be shared among machines, devices, application processing processes, background information systems, and operators.

The following clearly describes the technical solutions in embodiments of the present invention with reference to the accompanying drawings in the embodiments of the present invention. Apparently, the described embodiments are merely a part rather than all of the embodiments of the present invention. All other embodiments obtained by a person of ordinary skill in the art according to the embodiments of the present invention without creative efforts shall fall within the protection scope of the present invention.

### Embodiment 1

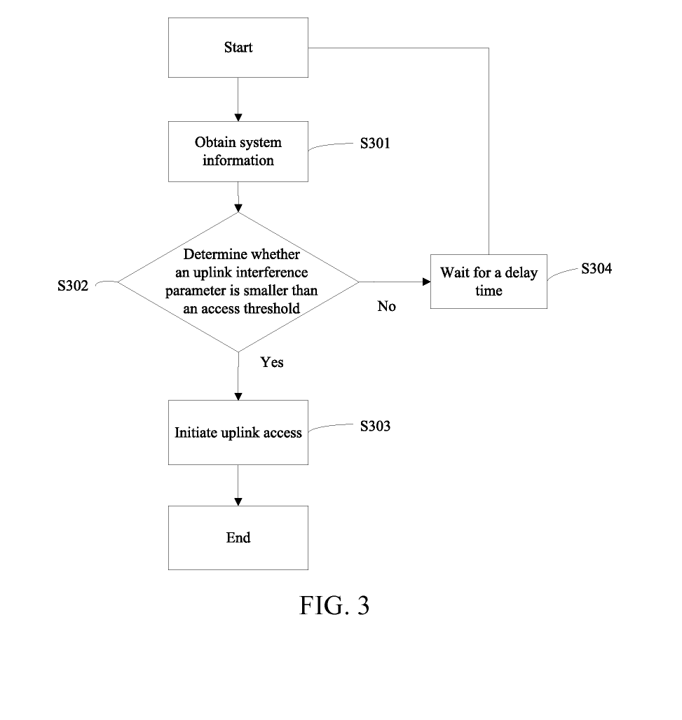

As shown in FIG. 3, an embodiment of the present invention provides an access control method, which includes the following steps:

S301. Obtain system information, where the system information includes an uplink interference parameter and an access threshold.

In this embodiment, specifically a user equipment UE may obtain current system information broadcast by a UTRAN from a base station in a cell where the UE is located, where the system information includes an uplink interference (UL interference) parameter and an access threshold. It should be known that the UTRAN may use system information block SIB7, SIB5, or SIB5bis to carry the uplink interference parameter and the access threshold when broadcasting system information. As stipulated in an existing 3GPP protocol, SIB7, SIB5, or SIB5bis is added with an information element for carrying the uplink interference parameter, which is used for open-loop power calculation. In view of protocol evolution, another existing system information block or a newly-defined SIB may also be used to carry the uplink interference parameter and the access threshold. The uplink interference parameter indicates the current uplink interference level of a cell where a UE is located. It should be understood that the uplink interference refers to interference when a UE transmits information or signaling to the UTRAN side. In the case of extensive access, strong uplink interference will be caused between UEs. A person skilled in the art should understand that the uplink interference parameter and the access threshold may be carried by the same SIB or different SIBs. For example, SIB7 is added with two IEs for carrying the uplink interference and the access threshold respectively. According to the access control method provided in the present invention, the uplink interference parameter and the access threshold can be obtained by periodically reading SIBs. If they are carried by different SIBs, a UE needs to periodically read multiple SIBs, which reduces the overall system efficiency.

S302. Determine whether the uplink interference parameter is smaller than the access threshold. If the uplink interference parameter is smaller than the access threshold, turn to step S303; otherwise, turn to step S304.

S303. If the uplink interference parameter is smaller than the access threshold, initiate uplink access to an access network.

It should be noted that the access network may specifically be a UMTS terrestrial radio access network (UMTS Terrestrial Radio Access Network, UTRAN) or an access network using another possible networking mode in the future and will not be described in the following. This embodiment takes the UTARAN as an example to describe access control according to the present invention and does not limit the protection scope of the present invention.

Specifically, when the uplink interference parameter is smaller than the access threshold for a cell where the UE is located, the UE initiates uplink access to an RNC on the UTRAN side and establishes a radio channel for transmitting and receiving data with the RNC on the UTRAN side by using radio resources of the cell where the UE is located.

S304. If the uplink interference parameter is not smaller than (namely, is larger than or equal to) the access threshold, re-perform steps S301 and S302 after a wait for a delay time.

Specifically, when a UE determines that the current uplink interference parameter is not smaller than the access threshold, the UE quits the access and after a wait for the delay time, re-obtains an uplink interference parameter and an access threshold of a next time point, so that access control can be performed on uplink access at the next time point.

It should be noted that during extensive access, UEs may cause great uplink interference to each other. In this embodiment, a UE may retreat by means of access control when the cell where the UE is located has a high uplink interference level. In this way, the uplink interference parameter of a next time point may become smaller. The UE can initiate another uplink access when the uplink interference parameter is smaller than the access threshold to avoid uplink congestion caused by extensive simultaneous access.

With the “always online” feature, smart phones periodically generate heartbeat data and continuously initiate system access. A special event such as a power failure takes place when low-priority M2M product users are accessing in batches in off-peak hours of common users, and therefore extensive access is triggered. A multitude of users try to access a system within a short time. All of these will lead to a rise in probability of uplink access congestion. In addition, uplink of self-interference systems such as a WCDMA system is an interference limited system. If a great many of UEs simultaneously access the system, a base station side may not meet a minimum demodulation threshold, and therefore UEs cannot be demodulated and even UL breakdown may occur. In this embodiment, a UE controls uplink access according to the uplink interference level and may quit access in the case of a high uplink interference level, which avoids uplink access congestion, reduces the congestion probability, and prevents uplink breakdown.

In this embodiment, it should be known that the procedure in which the UE initiates uplink access to the access network in step S303 may specifically include but is not limited to the following steps:

S203. The UE sends a preamble (Preamble) to uplink of a base station through a PRACH.

S204. The UE determines whether acknowledgement (Acknowledgement, ACK) information from a base station is received on an AICH. If the ACK information is received on the AICH, turn to step S205; if no ACK information is received, turn to S206.

S205. The UE initiates an RRC link setup procedure to the UTRAN for uplink access, so that the UE can establish a radio channel for transmitting and receiving data with the UTRAN by using radio resources of a cell where the UE is located.

S206. The UE determines whether the number of receptions of ACK information reaches a maximum allowed number of receptions. If the maximum allowed number of receptions is not exceeded, repeat step S204 after a wait for a delay time Backoff.

The foregoing describes a typical uplink access procedure initiated by a UE accessing a serving cell. A person skilled in the art should know that existing protocols such as the UMTS have defined signaling, channel establishment, and access procedures for uplink access initiated by a UE in an idle state. For example, a random access procedure initiated by a UE is stipulated in the 3GPP TS 25.321 protocol, and for an access procedure of the present invention, reference may be made to the random access procedure. Therefore, Based on the idea of access control based on the uplink interference level provided by the present invention, all embodiments obtained by a person of ordinary skill in the art by means of equivalent replacement or improvement based on other uplink access procedures without making creative efforts shall fall within the protection scope of the present invention.

In another implementation manner of the present invention, an access threshold may be a default value (Default) preset by an access network according to a product type, an access service class, or a service type of a UE. In a specific implementation, the access threshold may be set by the access network according to the product type of the UE, where the product type includes mobile phone of common user and M2M product. By setting different access thresholds, the access network separately performs access control over mobile phones of common users or M2M products.

Alternatively, the access threshold may be set by the access network according to the access service class of a current user of the UE. In a specific implementation, an RNC of the access network can work with an ASC for access control of UEs.

Alternatively, the access threshold may be set by the access network according to the service type of the UE, where the service type of the UE includes a circuit switch (Circuit Switch, CS) service and a packet switch (Packet Switch, PS) service. According to quality of service (Quality of Service, QoS), the PS service may further be classified as conversational class, streaming class, interactive class, and background class services. With lower priority, the access of the PS service can be independently controlled.

Alternatively, the access threshold may be a dynamic change value set by the access network according to an uplink interference parameter. Further, whether the access threshold changes dynamically depends on the access network implementation. For example, 1. The access network sets different access thresholds according to cell coverage such as mountainous areas, rural areas, and business districts; 2. The access network dynamically monitors the uplink interference level and adjusts the access threshold according to the uplink interference level; and 3. The access network presets multiple thresholds and then selects, from the preset multiple thresholds according to the uplink interference level, a threshold that matches the uplink interference level as the access threshold.

In another implementation manner of the present invention, a value range of an access threshold is (−110, −70) in a frequency division duplex (frequency division duplexing, FDD) system or (−110, −52) in a time division duplex (time division duplexing, TDD) system, in units of decibel milliwatt dBm.

Before step S304, in another implementation of the present invention, the method further includes:

obtaining a persistence scaling factor (Persistence scaling factor) and a dynamic persistence level (Dynamic persistence level) broadcast by an access network; and

according to a persistence value calculated according to the persistence scaling factor and the dynamic persistence level, selecting an upper limit of a random probability value of the persistence value as the delay time.

Specifically, a UE may calculate the delay time by using the following method. According to 3GPP 25.331 8.5.12, parameters of SIB5 include a persistence scaling factor for each access service class (Access Service Class, ASC). The persistence scaling factor is denoted by Si and has its value in the range of (0.9-0.1), and a persistence value is denoted by Pi. Parameters of SIB7 include a dynamic persistence level parameter, which is denoted by N, where N is an integer and 1≦N≦8. Under any level, the persistence value is calculated by using this formula: P(N)=2^{(N-1)}. Each time a UE accesses a timeslot, it randomly generates a probability value in the range of (0-1). If the probability value is smaller than the persistence value calculated according to the persistence scaling factor and the dynamic persistence level, the UE initiates access; otherwise, it waits for next access. Then the UE calculates an upper limit of a random probability value and uses the upper limit of the value as the delay time.

| | ASC i | | | | | | | |
|---|---|---|---|---|---|---|---|---|
| | 0 | 1 | 2 | 3 | 4 | 5 | 6 | 7 |
| Pi | 1 | P(N) | s2 P(N) | s3 P(N) | s4 P(N) | s5 P(N) | s6 P(N) | s7 P(N) |

In another implementation manner of the present invention, the system information broadcast by the access network may further include the delay time, which is a preset value sent by the access network through the system information. In a specific implementation, a dynamic value controlled by a UTRAN side may be added to SI, for example, an IE: a delay time, is added to SIB7, SIB5, or SIB5bis. In this way, a UE may also reads the delay time when reading an uplink interference parameter on SIB7, SIB5, or SIB5bis.

Further, a delay time of a next time point may be accumulated on the basis of a current delay time. When a current uplink interference is not smaller than an access threshold, a UE quits current access and waits for a delay time. If there are still a multitude of UEs initiating uplink access at the next time point, the uplink interference parameter of the next time point is still larger than the access threshold. To avoid NW congestion caused by simultaneous access of a great many of UEs, a random time is accumulated on the basis of the current delay time as the delay time of the next time point. After the current delay time plus the random time, the probability of simultaneous access of UEs will decrease at the next time point.

In this embodiment, the UE performs access control according to the uplink interference parameter. When the uplink interference level is high, access is delayed, and therefore, the probability of the uplink congestion problem caused by extensive simultaneous access is reduced.

### Embodiment 2

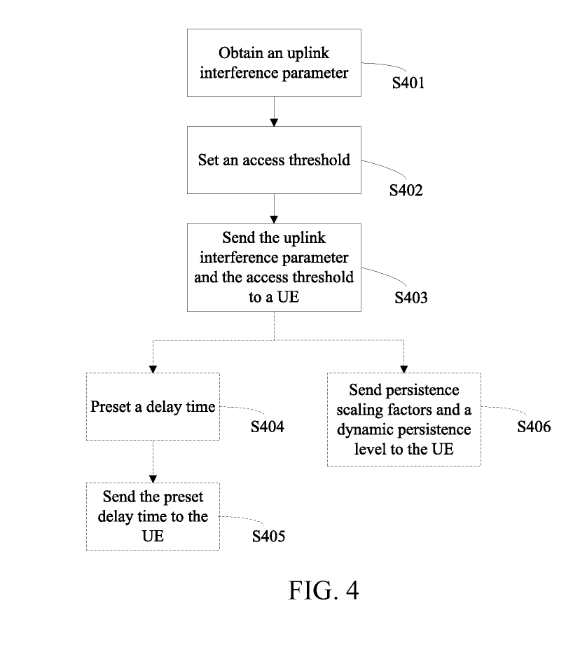

As shown in FIG. 4, this embodiment provides an access control method, which includes the following steps:

S401. Obtain a current uplink interference parameter (UL interference).

A person skilled in the art should know that existing 3GPP protocol have stipulated how to obtain the uplink interference parameter. For example, in system information in a WCDMA system, main parameters in SIB7 include the uplink interference parameter. In a specific implementation, an access network can calculate the uplink interference parameter according to a received total wideband power (received total wideband power, RTWP) of an antenna port of a NodeB. The RTWP reflects total noise of a cell, which is often used to measure the interference level of a base station and reflects received signal strength at an antenna port for receiving of a radio frequency module. In a specific implementation, an access network can determine an RTWP noise floor (RTWP measured without ongoing services) and sets a threshold for uplink load, for example, 50%. Then RTWP uplink is 3 dB. By measuring RTWP in real time (for example, every 1 s), an RNC/NodeB checks whether uplink capacity is limited and whether uplink is congested. If uplink is congested, the RNC/NodeB adjusts rates of UEs with services or makes low-priority users offline and controls access of UEs without services. Under this circumstance, UL interference=RTWP+SIR_TARGET_RACH−10 log SF, which is the required received signal power for a receiver of the NodeB. The foregoing only gives a simple description of how to obtain the uplink interference parameter but is not intended to limit the present invention.

S402. Set an access threshold.

S403. Send the uplink interference parameter and the access threshold to a user equipment UE, so that the UE performs access control according to the uplink interference parameter and the access threshold.

In this embodiment, an access network can add an IE carrying the uplink interference parameter and an IE carrying the access threshold to the system information by means of IE expansion. For example, the IE carrying the uplink interference parameter and the IE carrying the access threshold can be added to SIB7, SIB5, or SIB5bis. Generally, the uplink interference parameter and the access threshold can be carried by the same SIB to avoid system efficiency from being affected when a UE obtains multiple SIBs periodically. However, in other implementation manners of the present invention, different SIBs may be used to carry the uplink interference parameter and the access threshold.

The access network sends the uplink interference parameter and the access threshold to the UE, so that the UE performs access control according to the received uplink interference parameter and the access threshold during extensive access in special scenarios such as a power failure. As a result, the probability of problems such as uplink congestion and system breakdown is reduced when a multitude of users are trying to access a system within a short time.

In another implementation manner of the present invention, the method further includes the following steps:

S404. Preset a delay time.

S405. Send the delay time to the UE, so that when the uplink interference parameter is not smaller than the access threshold, the UE, after a wait for the delay time, re-obtains an uplink interference parameter and an access threshold of a next time point and performs access control.

In another implementation manner of the present invention, the method further includes the following step:

S406. Send a persistence scaling factor and a dynamic persistence level to the UE, so that when the uplink interference parameter is not smaller than the access threshold, the UE calculates a delay time according to the persistence scaling factor and the dynamic persistence level, and after a wait for the delay time, re-obtains an uplink interference parameter and an access threshold of a next time point and performs access control. For details about how to calculate the delay time according to the persistence scaling factor and the dynamic persistence level, reference may be made to the description in Embodiment 1, which is not described again herein.

In another implementation manner of the present invention, in step S402, specifically, the access network can set a corresponding access threshold for the UE according to a product type, where the product type includes mobile phone of common user and M2M product. By setting different access thresholds, the access network separately performs access control over mobile phones of common users or M2M products. For example, an M2M uplink interference access threshold (M2M UL interference access threshold) parameter may be added to SIB7, SIB5, or SIB5bis for access control over M2M products.

In another implementation manner of the present invention, in step S402, specifically, the access network may further set a corresponding access threshold according to an access service class of the UE. In a specific implementation, an RNC of the access network can work with an ASC for control. For example, an ASC uplink interference access threshold (ASC UL interference access threshold) parameter is added to SIB7, SIB5, or SIB5bis for access control of the UE.

In another implementation manner of the present invention, in step S402, in a specific implementation, the access network may further set a corresponding access threshold according to a service type of the UE, where the service type of the UE includes a circuit switch (Circuit Switch, CS) service and a packet switch (Packet Switch, PS) service. According to quality of service (Quality of Service, QoS), the PS service may further be classified as conversational class, streaming class, interactive class, and background class services. With lower priority, the access of the PS service can be independently controlled. For example, a new uplink interference access threshold (PS UL interference access threshold) for PS services is added to SIB7, SIB5, or SIB5bis on a UTRAN side to control access of a PS service initiated by a user.

### Embodiment 3

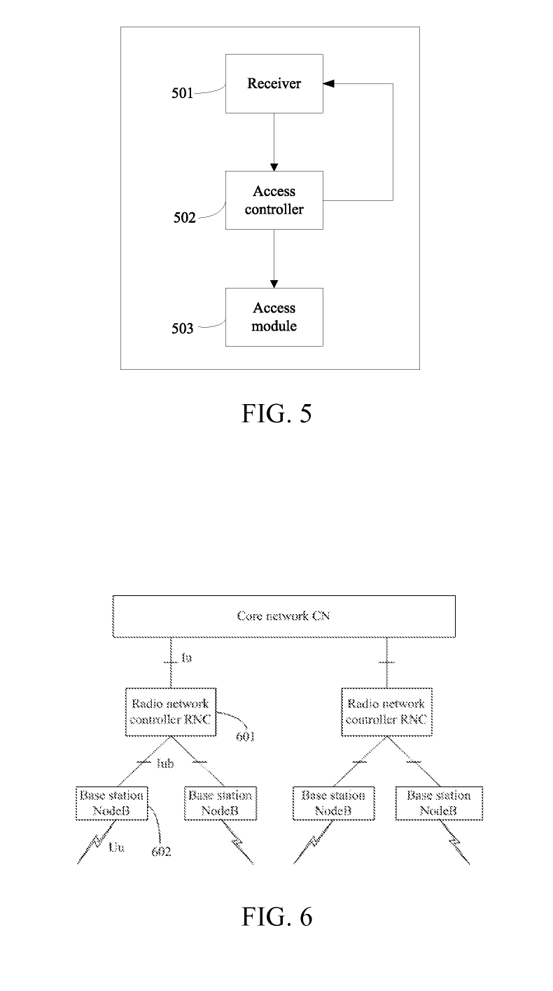

As shown in FIG. 5, the embodiment of the present invention provides a user equipment UE, including:

a receiver 501, configured to obtain current system information, where the system information includes an uplink interference parameter and an access threshold;

The system information obtained by the UE is broadcast by a base station in a cell where the UE is located. The UE obtains an uplink interference parameter and an access threshold required for access control. For details, reference may be made to the description in Embodiment 1;

an access controller 502, configured to determine whether the uplink interference parameter is smaller than the access threshold; and

an access module 503, configured to initiate uplink access to an access network when the uplink interference parameter is smaller than the access threshold.

The uplink access procedure has been elaborated in the background and Embodiment 1 and is not described again herein.

The user equipment provided in this embodiment can perform access control according to an uplink interference level. As a result, the probability of the uplink access congestion problem can be reduced when a multitude of users are trying to access a system within a short time in special scenarios such as a power failure.

Further, in this embodiment, the system information obtained by the receiver 501 further includes a delay time. When the access module 503 determines that the uplink interference parameter is not smaller than (is larger than or equal to) the access threshold, the receiver 501 is further configured to re-obtain an uplink interference parameter and an access threshold of a next time point after a wait for the delay time.

In another implementation manner of the present invention, the receiver 501 is further configured to:

obtain a persistence scaling factor and a dynamic persistence level broadcast by the access network, and according to a persistence value calculated according to the received persistence scaling factor and the dynamic persistence level, select an upper limit of a random probability value of the persistence value as the delay time; and

when the uplink interference parameter is not smaller than the access threshold, re-obtain an uplink interference parameter and an access threshold of a next point of time after a wait for the delay time.

### Embodiment 4

As shown in FIG. 6, the embodiment of the present invention provides an access network, including:

a radio network controller 601, configured to obtain an uplink interference parameter and set an access threshold; and

a base station 602, configured to send the uplink interference parameter and the access threshold to a user equipment UE, so that the UE performs access control according to the uplink interference parameter and the access threshold.

Specifically, the base station 602 (NodeB) carries the uplink interference parameter and the access threshold in system information by broadcasting the system information and sends them to the UE.

Further, the radio network controller 601 (RNC) is further configured to preset a delay time and the base station 602 is further configured to send the delay time to the UE, so that when the uplink interference parameter is not smaller than the access threshold, the UE, after a wait for the delay time, re-obtains an uplink interference parameter and an access threshold of a next time point and performs access control.

In another implementation manner of the present invention, the base station 602 is further configured to send a persistence scaling factor and a dynamic persistence level to the UE, so that when the uplink interference parameter is not smaller than the access threshold, the UE calculates a delay time according to the persistence scaling factor and the dynamic persistence level, and after a wait for the delay time, re-obtains an uplink interference parameter and an access threshold of a next time point and performs access control.

### Embodiment 5

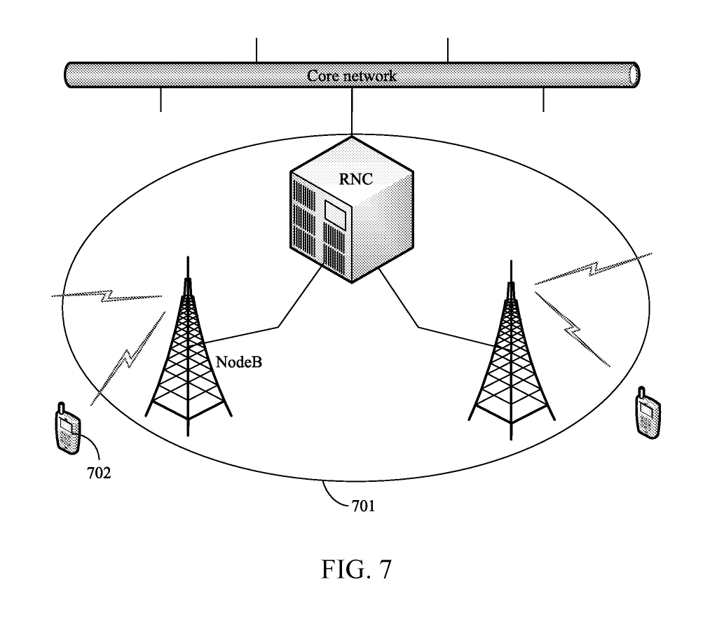

As shown in FIG. 7, an embodiment of the present invention provides a communications system, including an access network 701 and a user equipment (UE) 702.

The access network 701 obtains an uplink interference parameter and sets an access threshold, and sends the uplink interference parameter and the access threshold to the UE 702.

The UE 702 obtains the uplink interference parameter and the access threshold and determines whether the uplink interference parameter is smaller than the access threshold.

When the uplink interference parameter is smaller than the access threshold, the UE 702 initiates uplink access to the access network 701.

In another implementation manner of the present invention, the access network 701 further presets a delay time and sends the delay time to the UE 702. The UE 702 obtains the delay time. When the uplink interference parameter is not smaller than the access threshold, the UE 702, after a wait for the delay time, re-obtains an uplink interference parameter and an access threshold of a next time point and performs uplink access control.

In another implementation manner of the present invention, the access network 701 further sends a persistence scaling factor and a dynamic persistence level to the UE 702. The UE 702 obtains the persistence scaling factor and the dynamic persistence level, and according to a persistence value calculated according to the persistence scaling factor and the dynamic persistence level, selects an upper limit of a random probability value of the persistence value as the delay time. When the uplink interference parameter is not smaller than the access threshold, after a wait for the delay time, the UE 702 re-obtains an uplink interference parameter and an access threshold of a next time point.

It should be known that the communications system according to this embodiment includes the user equipment provided by Embodiment 3 and the access network provided by Embodiment 4. For specific features, reference may be made to Embodiment 3 and Embodiment 4. Correspondingly, for the communications system provided by this embodiment, reference may also be made to the access control method implemented on a UE side provided by Embodiment 1 and the access control method implemented on an access network side provided by Embodiment 2, which are not described again herein.

It should be understood that the specific embodiments described herein are merely common embodiments of the present invention, and are not intended to limit the present invention. Any modification, equivalent replacement, or improvement made within the principle of the present invention shall all fall within the protection scope of the present invention.

1-22. (canceled)

23. An access control method, comprising:
obtaining system information, wherein the system information comprises an uplink interference parameter and an access threshold;
determining whether the uplink interference parameter is smaller than the access threshold; and
initiating uplink access to an access network when the uplink interference parameter is smaller than the access threshold.

24. The method according to claim 23, further comprising, when the uplink interference parameter is not smaller than the access threshold, re-obtaining system information and re-determining whether the uplink interference parameter is smaller than the access threshold, the re-obtaining and re-determining performed after a delay time.

25. The method according to claim 24, further comprising:
obtaining a persistence scaling factor and a dynamic persistence level; and
according to a persistence value calculated according to the persistence scaling factor and the dynamic persistence level, selecting an upper limit of a random probability value of the persistence value as the delay time.

26. The method according to claim 24, wherein the system information further comprises the delay time.

27. The method according to claim 23, wherein the access threshold is a default value preset by the access network according to a product type, an access service class, or a service type of a user equipment, or the access threshold is a dynamic change value set by the access network according to the uplink interference parameter.

28. The method according to claim 23, wherein a value range of the access threshold is (−110, −70) in a frequency division duplex system or (−110, −52) in a time division duplex system, in units of dBm.

29. An access control method, comprising:
obtaining an uplink interference parameter;
setting an access threshold; and
sending the uplink interference parameter and the access threshold to a user equipment (UE), so that the UE performs access control according to the uplink interference parameter and the access threshold.

30. The method according to claim 29, further comprising:
presetting a delay time; and
sending the delay time to the UE, so that when the uplink interference parameter is not smaller than the access threshold, the UE, after a wait for the delay time, re-obtains an uplink interference parameter and an access threshold of a next time point and performs access control.

31. The method according to claim 29, further comprising sending a persistence scaling factor and a dynamic persistence level to the UE, so that when the uplink interference parameter is not smaller than the access threshold, the UE calculates a delay time according to the persistence scaling factor and the dynamic persistence level, and after a wait for the delay time, re-obtains an uplink interference parameter and an access threshold of a next time point and performs access control.

32. The method according to claim 29, wherein the step of setting an access threshold comprises setting a corresponding access threshold according to a product type of the UE, wherein the product type comprises mobile phone or machine-to-machine product.

33. The method according to claim 29, wherein setting the access threshold comprises setting a corresponding access threshold according to an access service class of the UE.

34. The method according to claim 29, wherein setting the access threshold comprises setting a corresponding access threshold according to a service type of the UE, wherein the service type comprises a circuit switch (CS) service and a packet switch (PS) service.

35. The method according to claim 34, wherein the service type comprises a PS service and wherein the PS service further comprises a conversational class service, a streaming class service, an interactive class service, and a background class service.

36. A user equipment, comprising:
a receiver, configured to obtain system information, wherein the system information comprises an uplink interference parameter and an access threshold;
an access controller, configured to determine whether the uplink interference parameter is smaller than the access threshold; and
an access module, configured to initiate uplink access to an access network when the uplink interference parameter is smaller than the access threshold.

37. The user equipment according to claim 36, wherein the system information obtained by the receiver further comprises a delay time and, when the uplink interference parameter is not smaller than the access threshold, the receiver is further configured to, after a wait for the delay time, re-obtain an uplink interference parameter and an access threshold of a next time point.

38. The user equipment according to claim 36, wherein the receiver is further configured to:
obtain a persistence scaling factor and a dynamic persistence level broadcast by the access network;
select an upper limit of a random probability value of the persistence value as a delay time according to a persistence value calculated according to the persistence scaling factor and the dynamic persistence level; and
when the uplink interference parameter is not smaller than the access threshold, after a wait for the delay time, re-obtain an uplink interference parameter and an access threshold of a next time point.

39. An access network, comprising:
a radio network controller, configured to obtain an uplink interference parameter and set an access threshold; and
a base station, configured to send the uplink interference parameter and the access threshold to a user equipment (UE), so that the UE performs access control according to the uplink interference parameter and the access threshold.

40. The access network according to claim 39, wherein the radio network controller is further configured to preset a delay time; and
wherein the base station is further configured to send the delay time to the UE, so that when the uplink interference parameter is not smaller than the access threshold, the UE, after a wait for the delay time, re-obtains an uplink interference parameter and an access threshold of a next time point and performs access control.

41. The access network according to claim 39, wherein, the base station is further configured to send a persistence scaling factor and a dynamic persistence level to the UE, so that when the uplink interference parameter is not smaller than the access threshold, the UE calculates a delay time according to the persistence scaling factor and the dynamic persistence level, and after a wait for the delay time, re-obtains an uplink interference parameter and an access threshold of a next time point and performs access control.

42. A communications system, comprising:
an access network; and
a user equipment (UE);
wherein the access network is configured to obtain an uplink interference parameter, to set an access threshold, and to send the uplink interference parameter and the access threshold to the UE;
wherein the UE is configured to obtain the uplink interference parameter and the access threshold and to determine whether the uplink interference parameter is smaller than the access threshold; and
wherein, when the uplink interference parameter is smaller than the access threshold, the UE is configured to initiate uplink access to the access network.

43. The communications system according to claim 42, wherein the access network is further configured to preset a delay time and send the delay time to the UE; and
wherein, when the uplink interference parameter is not smaller than the access threshold, the UE, after a wait for the delay time, the access network is further configured re-obtain an uplink interference parameter and an access threshold of a next time point and to perform uplink access control.

44. The communications system according to claim 42, wherein the access network is further configured to send a persistence scaling factor and a dynamic persistence level to the UE;
wherein the UE is further configured to obtain the persistence scaling factor and the dynamic persistence level sent by the access network and, according to a persistence value calculated according to the persistence scaling factor and the dynamic persistence level, to select an upper limit of a random probability value of the persistence value as a delay time; and
wherein the UE is configured to, when the uplink interference parameter is not smaller than the access threshold, to, after a wait for the delay time, re-obtain an uplink interference parameter and an access threshold of a next time point.
